(19) United States
(12) Patent Application Publication
(10) Pub. No.: US 2025/0303420 A1
(43) Pub. Date: Oct. 2, 2025

(54) Digital Microfluidic (DMF) Devices, Systems, and Methods for Spectrochemical Analysis

(71) Applicant: Nicoya Lifesciences Inc., Kitchener (CA)

(72) Inventors: Ryan Cameron Denomme, Conestogo (CA); Sebastian Von Der Ecken, Concord (CA); Roberto C. Arbulu, Temecula, CA (US); Gordon H. Hall, Cambridge (CA); Michael Piazza, Etobicoke (CA)

(21) Appl. No.: 19/092,882

(22) Filed: Mar. 27, 2025

Related U.S. Application Data
(60) Provisional application No. 63/571,256, filed on Mar. 28, 2024.

(51) Int. Cl. B01L 3/00; G01N 21/31

(52) U.S. Cl. CPC B01L 3/502784; B01L 3/502715; G01N 21/31; B01L 2200/0673; B01L 2300/0654; B01L 2300/0663

(57) ABSTRACT

Described is a digital microfluidics system and method for measuring an analyte concentration in a droplet. Droplet movement operations can be used to carry out biological, biochemical, and chemical reactions, measurements, and experiments and a light source and light detector or spectrophotometer can be used to transmit light through a droplet to determine the absorbance of light through the droplet to calculate a concentration of analyte in the droplet.

### CROSS-REFERENCE TO RELATED APPLICATIONS

The present application claims priority under 35 U.S.C. § 119 to U.S. Provisional Patent Application No. 63/571,256 filed on Mar. 28, 2024, the entire contents of which are hereby incorporated by reference.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### TECHNICAL FIELD

The subject matter relates generally to the detection of molecules, such as DNA, proteins, small organic molecules, and the like, and more particularly to a device, system, and method for determining the concentration of molecules or analyte in solution using spectrophotometry in a microfluidic system.

### BACKGROUND

Fluid mixtures are often characterized using optical techniques such as photometry and spectrophotometry to determine the amounts and/or characteristics of dissolved and suspended components therein. Traditional spectrophotometry methods to characterize a fluid sample generally involve the use of a sample-holding cuvette of a standard known path length between two facing optically transparent surfaces. The fluid sample is put into the cuvette to measure the transmission or absorbance of light through the cuvette and a concentration and/or other characteristics of the components therein can be measured based on the change in light sent from a light source and received at a sensor relative to the known cuvette path length. However, these traditional spectroscopy methods require a certain minimal volume of fluid to fill the path length distance.

In one example of changing the path length of a fluid sample for use in spectrophotometry, U.S. Pat. No. 8,223,338 B2 to Robertson et al., describes a device for measuring the concentration of an analyte in a fluid in a surface-tension-held environment. The device has two opposing optical fibers mounted within a non-rotating shaft of a linear actuator, the optical fibers configured to transmit and receive light along an optical path. A path length sensor between the opposing optical fibers provides a displacement measurement between the opposing optical fibers to enable the determination of a path length between the fibers and therefore absorbance measurements through the fluid.

Digital microfluidics (DMF) devices and systems can be used to manipulate and move droplets around on a cartridge or chip using digital microfluidics (DMF) mediated droplet operations to carry out biological and chemical lab-on-a-chip measurements and experiments. DMF devices are particularly advantageous in their ability to handle low volumes of fluid, such as reagents or samples. In one example of a DMF device for measuring absorbance, U.S. Pat. No. 8,208,146 B2 to Srinivasan et al., describes optical coupling methods to enhance absorbance signal in a DMF device. Methods of enhancing signal include total internal reflection of the input light through the droplet, modifications to the geometry of the device to stretch the droplet, and elongation of the droplet using electric fields.

This background information is provided for the purpose of making known information believed by the applicant to be of possible relevance to the present invention. No admission is necessarily intended, nor should be construed, that any of the preceding information constitutes prior art against the present invention.

### SUMMARY

An object of the present invention is to provide a device, system, and method for determining the concentration of molecules or in solution using spectrophotometry in a microfluidic system.

Embodiments of the present invention as recited herein may be combined in any combination or permutation.

In one aspect, the present disclosure provides a digital microfluidic (DMF) device for the spectrochemical analysis of a fluid droplet. In some embodiments, the DMF device includes an input configured to cause light to be transmitted through a fluid droplet on a surface, and an output for collecting light transmitted through the fluid droplet on the surface. The surface is configured to perform one or more droplet operations on the fluid droplet thereby causing a change in a shape of the fluid droplet, and the change in the shape of the fluid droplet alters a path length between the input and the output.

In some embodiments, the DMF device is configured to electronically connect to a DMF system. In some embodiments, the DMF system includes a light source electronically connected to the input for providing light to the input, a detector electronically connected to the output for receiving light from the output, and a controller electronically connected to the surface, the light source, the detector. In some embodiments, the controller is configured to cause the surface to perform the one or more droplet operations on the fluid droplet thereby altering the path length between the input and the output. In some embodiments, the controller is configured to cause the light source to transmit light to the input. In some embodiments, the controller is configured to cause the detector to receive light from the output. In some embodiments, the controller is configured to process a signal generated by the detector in response to receiving the light from the output. In some embodiments, the controller is configured to generate a spectrum based on the signal generated by the detector.

In some embodiments, the spectrum generated by the controller is proportional to the path length.

In some embodiments, either the input, the output, or both the input and the output is an optical guide.

In some embodiments, the optical guide is selected from: a lens, a mirror, an optical fiber, or a fenestration.

In some embodiments, optical guide is either disposed on or adjacent to the surface.

In some embodiments, optical guide is configured to engagingly contact the fluid droplet.

In some embodiments, the optical guide is moveable thereby enabling the optical guide to engagingly contact the fluid droplet.

In some embodiments, the change in the shape of the fluid droplet caused by the one or more droplet operations causes the fluid droplet to engagingly contact the optical guide.

In some embodiments, the DMF device is configured to electronically connect to a DMF system. In some embodiments, the DMF system includes a controller electronically connected to the surface, the input, and the output. In some embodiments, the controller is configured to cause the surface to perform the one or more droplet operations on the fluid droplet thereby altering the path length between the input and the output. In some embodiments, the controller is configured to cause the input to transmit light to through the fluid droplet. In some embodiments, the controller is configured to cause the output to receive light transmitted through the fluid droplet. In some embodiments, the controller is configured to process a signal generated by the output in response to receiving the light transmitted through the fluid droplet. In some embodiments, the controller is configured to generate a spectrum based on the signal generated by the output.

In some embodiments, the spectrum generated by the controller is proportional to the path length.

In some embodiments, the input is a light source.

In some embodiments, the light source is either disposed on or adjacent to the surface.

In some embodiments, the light source is configured to engagingly contact the fluid droplet.

In some embodiments, the light source is moveable thereby enabling the light source to engagingly contact the fluid droplet.

In some embodiments, the change in the shape of the fluid droplet caused by the one or more droplet operations causes the fluid droplet to engagingly contact the light source.

In some embodiments, the output is a sensor.

In some embodiments, the sensor is either disposed on or adjacent to the surface.

In some embodiments, the sensor is configured to engagingly contact the fluid droplet.

In some embodiments, the sensor is moveable thereby enabling the sensor to engagingly contact the fluid droplet.

In some embodiments, the change in the shape of the fluid droplet caused by the one or more droplet operations causes the fluid droplet to engagingly contact the sensor.

In some embodiments, the DMF device further includes a SPR sensor or a LSPR sensor.

In another aspect, the present disclosure provides a method for spectrochemical analysis using a DMF device. In some embodiments, the method includes the step of providing a fluid droplet to a surface of a digital microfluidic (DMF) device. In some embodiments, the DMF device includes an input configured to cause light to be transmitted through the fluid droplet on a surface, and an output for collecting light transmitted through the fluid droplet on the surface. In some embodiments, the method also includes positioning the fluid droplet between the input and the output. In some embodiments, the method further includes changing a shape of the fluid droplet thereby changing a path length between the input and the output. In some embodiments, the method includes transmitting light via the input through the fluid droplet. In some embodiments, the method includes collecting light transmitted through the fluid droplet via the output. In some embodiments, the method includes generating a spectrum using the light collected by the output, wherein the intensity of the spectrum is proportional to the path length.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a block diagram of an example of a digital microfluidics (DMF) system;

FIG. 2 illustrates a top view of a digital microfluidics (DMF) actuator array;

FIG. 3A illustrates a side cross-sectional view of a digital microfluidics (DMF) actuator array;

FIG. 3B illustrates a side cross-sectional view of a digital microfluidics (DMF) actuator array with a droplet in a droplet operations gap;

FIG. 4 illustrates a side cross-sectional view of a digital microfluidics (DMF) actuator array and a spectrochemical detection device;

FIG. 5A illustrates a top view of DMF actuator array with a droplet stretched over multiple actuators in a first configuration;

FIG. 5B illustrates a top view of DMF actuator array with a droplet stretched over multiple actuators in a second different configuration than FIG. 5A;

FIG. 5C illustrates a top view of DMF actuator array with a droplet stretched over multiple actuators in a third different configuration than FIG. 5A and FIG. 5B;

FIG. 5D illustrates a top view of DMF actuator array with a droplet stretched over multiple actuators in a fourth different configuration than FIGS. 5A-5C;

FIG. 5E illustrates a top view of DMF actuator array with a droplet stretched over multiple actuators in a fifth different configuration than FIGS. 5A-5D;

FIGS. 6A-6E illustrate respective top views of a DMF actuator array with droplets of various sizes positioned over different portions of the array, the actuators transposing the droplets across the array thereby causing the droplets to merge along a path length between an input optical fiber and output optical fiber;

FIGS. 7A-7C illustrate respective top views of another DMF actuator array with droplets of various sizes positioned over different portions of the array, the actuators transposing the droplets across the array thereby causing the droplets to be positioned along a path length between an input optical fiber and output optical fiber;

FIGS. 8A-8C illustrate respective top views of another DMF actuator array with a droplet stretched in different configurations (i.e., vertically, T-shaped, and horizontally) over a portion of the array relative to an optical path between an input optical fiber and output optical fiber;

FIGS. 9A-9C illustrate views of a light source and detector having one or more optical fibers for analysis of a droplet in a DMF device;

FIGS. 10A and 10B illustrate views of a light source with an adjustable input optical fiber in a retracted and extended configuration, respectively;

FIGS. 11A and 11B illustrate views of a light detector with an adjustable output optical fiber in a retracted and extended configuration, respectively;

FIG. 12A illustrates a top view of a DMF actuator array with adjustable input and output optical fibers in an extended configuration and a droplet stretched along a path length therebetween;

FIG. 12B illustrates the top view of a DMF actuator array with adjustable input and output optical fibers being retracted with a droplet repositioned away from a path length therebetween;

FIG. 12C illustrates the top view of a DMF actuator array with adjustable input and output optical fibers in a retracted configuration and a droplet repositioned away from a path length therebetween;

FIG. 12D illustrates the top view of a DMF actuator array with adjustable input and output optical fibers in a retracted configuration and a droplet stretched along a path length therebetween;

FIG. 13 is a flowchart illustrating an example method for determining a property, such as, for example, a concentration, of analyte in a solution using spectrophotometry in a DMF system with input/output optical fibers having fixed positions;

FIG. 14 is a flowchart illustrating an example method for determining a property, such as, for example, concentration, of analyte in a solution using spectrophotometry in a DMF system with input/output optical fibers having adjustable positions; and

FIG. 15 illustrates a top view of a DMF actuator array and a droplet with a single input and output (i.e., dual mode) optical fiber and reflective elements.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount. As used herein, the term “about” refers to an amount that is near the stated amount by 10%, 5%, or 1%, including increments therein. As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B, and C”, “at least one of A, B, or C”, “one or more of A, B, and C”, “one or more of A, B, or C” and “A, B, and/or C” means A alone, B alone, C alone, A and B together, A and C together, B and C together, or A, B, and C together.

As used herein, the terms “connect” and “connected” refer to any direct or indirect physical association between elements or features of the present disclosure. Accordingly, these terms may be understood to denote elements or features that are partly or completely contained within one another, attached, coupled, disposed on, joined together, in communication with, operatively associated with, etc., even if there are other elements or features intervening between the elements or features described as being connected.

Herein is provided a digital microfluidic (DMF) system, device and method for measuring a property such as, for example, concentration, of an analyte in a droplet. A digital microfluidics (DMF) device, also referred to as a cartridge or cassette, is capable of using digital microfluidics (DMF) mediated droplet operations to carry out biological, biochemical, and chemical reactions, measurements, and experiments. The presently described DMF system utilizes a light source to transmit light through a droplet to a detector or spectrophotometer to measure the transmission or absorbance of light through the droplet. The detector may optionally record the spectra of the incident and transmitted light. Measuring the transmission or absorbance of light through the droplet may enable the determination of a concentration and/or other characteristics of an analyte in the droplet. Actuation of droplets in the DMF system as well as placement of input (i.e., transmitting) and output (i.e., receiving) optical fibers relative to droplets is achieved by changing the hydrophilicity at the surface of each droplet actuator in an actuator array. Actuators in DMF device may be referred to as electrodes, pads, or pixels depending on the underlying technology. For example, in some devices the actuator may be a thin-film transistor (TFT) pixel, in others, it may be a printed circuit board (PCB) pad. The actuator function may also be done directly as an applied voltage, it may be an induced voltage from another source (for example, an optoelectric device where light creates a field), or it may be triggered as a combination (for example, an electric or optical signal that triggers a larger field). Regardless of the mechanisms used, the actuators enable control of droplet orientation on the actuator array, which in turn enables control of the optical path length through the droplet. Droplet operations actuated by the droplet actuators in the DMF device can include, for example, droplet merging, splitting, shaping, dispensing, and/or diluting. The DMF device can be used to execute any number of experimental assays by creating and mixing different droplets in a defined sequence and timing. These assays may be measured by detecting the changes in light transmission or absorbance.

The DMF system comprises a controller, a DMF interface, a detection system, one or more droplet actuators, and one or more fluidic control mechanisms. The DMF device can have a variety of actuator configurations to suit a desired purpose, and can be varied at least in the number, size, shape, and/or arrangement of the actuators. The DMF device can have a variety of actuator arrangements for fluidic manipulation, wherein each of the actuator arrangements may include, but is not limited to, any arrangements of lines, paths, shapes, and arrays of droplet operations actuators. Further, the presently described DMF system and device may include an SPR (surface plasmon resonance) sensor which can be used in multiplexed analysis.

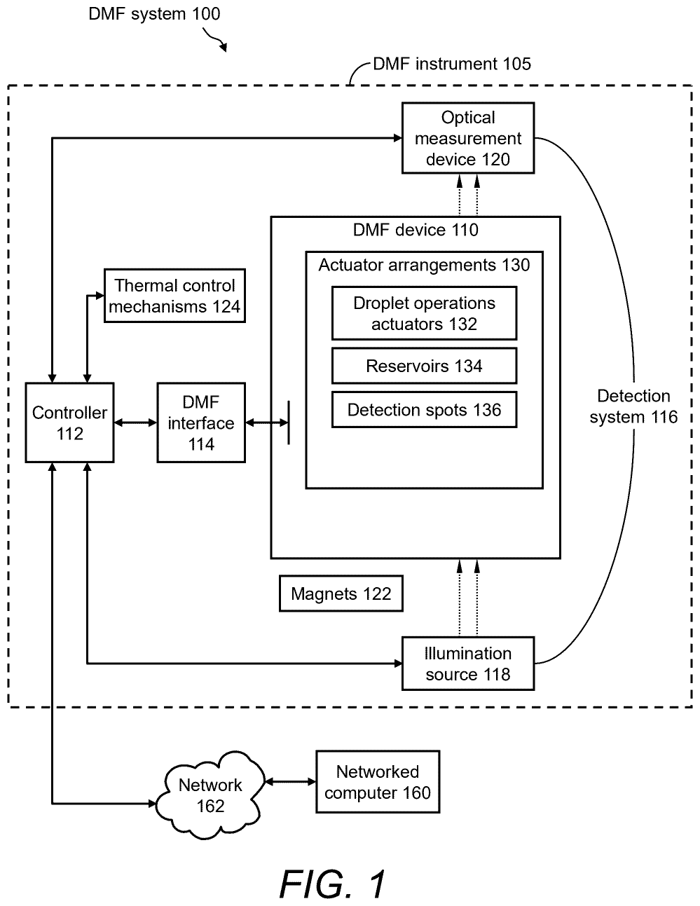

Referring now to FIG. 1, a block diagram of an example of a digital microfluidics (DMF) system 100 for analyzing an analyte in a droplet, in accordance with an embodiment of the disclosure, is shown. In this example, DMF system 100 may include a DMF instrument 105. Further, DMF instrument 105 may engage a DMF device (or cartridge) 110 along with any supporting components. DMF device 110 of DMF system 100 may be, for example, any fluidics device or cartridge, microfluidic device or cartridge, digital microfluidic (DMF) device or cartridge, droplet actuator, flow cell device or cartridge, and the like. In various embodiments, DMF device 110 may support automated processes to manipulate, process, and/or analyze biological materials. DMF device 110 may be provided, for example, as a disposable and/or reusable device or cartridge. DMF device 110 may be used for processing biological and/or chemical materials. Generally, DMF device 110 may facilitate DMF capabilities for fluidic actuation including droplet transporting, merging, mixing, splitting, dispensing, diluting, agitating, deforming (shaping), and/or other types of droplet operations. Applications of these DMF capabilities may include, for example, sample preparation and waste removal. In one example, the DMF capabilities of DMF device 110 of DMF system 100 may be used to perform assays, such as, but not limited to, PCR protocols, enzyme-linked immunosorbent assays, cell viability studies, nucleic acid quantitation, and more. For example, the DMF capabilities of DMF device 110 and DMF system 100 may be used for processing a patient sample and performing an assay. In DMF system 100, DMF device 110 may be provided, for example, as a disposable and/or reusable cartridge which may be reversibly engaged with DMF system 100.

DMF system 100 may further comprise a controller 112, a DMF interface 114, a detection system 116, one or more magnets 122, and one or more thermal control mechanisms 124. Controller 112 may be electrically coupled to the various hardware components of DMF system 100, such as to DMF device 110, detection system 116, magnets 122, and thermal control mechanisms 124. In particular, controller 112 may be electrically coupled to DMF device 110 via DMF interface 114, wherein DMF interface 114 may be, for example, a pluggable interface for connecting mechanically and electrically to DMF device 110. Detection system 116 may be any detection mechanism that can be used to accurately determine the presence or absence of a defined analyte and/or target component in different materials and to sensitively quantify the amount of analyte and/or target components present in a sample. Detection system 116 may be, for example, an optical measurement system that includes an illumination source 118 and an optical measurement device 120. For example, detection system 116 may be a fluorimeter, photometer, or spectrophotometer that provides both excitation and detection. The illumination source 118 (i.e., light source) may be, for example, a light source capable of emitting light between 380 nm and 800 nm, such as, but not limited to, a white light-emitting diode (LED), a halogen bulb, an arc lamp, an incandescent lamp, lasers, and the like. Illumination source 118 is not limited to a white light source. Illumination source 118 may be any color or wavelength of light that is useful in DMF system 100, and may be a single wavelength or broadband emitter. Optical measurement device 120 (i.e., detector) may be used to detect light from DMF device 110. Illumination source 118 may optionally be a white light source with an optical filter to control the wavelength of excitation. The optical filter may optionally be tunable to different wavelengths. Optical measurement device 120 may be, for example, a charge-coupled device (CCD), a photodetector, a spectrometer, a photodiode array, any other arrays or any combination thereof. Further, DMF system 100 is not limited to one detection system 116 only (e.g., one illumination source 118 and one optical measurement device 120 only). Detection system 116 may, for example, be configured to measure an overall amount of transmission or absorbance of a droplet or droplets or it may measure a spectra of the transmission or absorbance. DMF system 100 may comprise multiple detection systems 116 (e.g., multiple illumination sources 118 and/or multiple optical measurement devices 120) to support detection of multiple droplets and/or multiplexed analysis. The position of the components of the detection system 116 may also be dynamic in that their position and/or orientation may be changed. This may be accomplished by, for example, placing the components on a rail where they can be moved by a motor or piezoelectric actuator. In another embodiment, the components of the detection system 116 are interfaced with other components through an optical fiber. The optical fiber may be positioned using a reel or roll that can control the fiber extension.

Controller 112 may, for example, be a general-purpose computer, special-purpose computer, personal computer, microprocessor, or other programmable data processing apparatus. Controller 112 may provide processing capabilities, such as storing, interpreting, and/or executing software instructions, as well as controlling the overall operations of DMF system 100. The software instructions may comprise machine-readable code stored in non-transitory memory that is accessible by the controller 112 for the execution of the instructions. Controller 112 may be configured and programmed to control data and/or power aspects of DMF system 100. Further, data storage (not shown) may be built into or provided separate from controller 112. In some embodiments, controller 112 may include one or more output interfaces connecting processing units to output devices, such as a graphical user interface (GUI). This enables DMF system 100 to communicate the results of various processing operations to users, such as experiment results. Software instructions may be stored in memory unit(s) of controller 112 and may include conventional semiconductor random access memory (RAM) or other forms of memory known in the art; and/or software instructions may be stored in the form of program code on one or more computer-readable storage media, such as a hard drive, USB drive, read/write CD-ROM, DVD, tape drive, flash drive, optical drive, etc. These instructions may be executed in response to a user's interaction with DMF system 100 via an input device (not shown).

Generally, controller 112 may be used to manage any functions of DMF system 100. For example, controller 112 may be used to manage the operations of detection system 116 (e.g., illumination source 118, optical measurement device 120 and other components), magnets 122, thermal control mechanisms 124, and any other instrumentation or components (not shown) in relation to DMF device 110. For example, optionally, one or more thermal control mechanisms 124 can be used to control the operating temperature of one or more actuator arrays of DMF device 110. Examples of thermal control mechanisms 124 may include Peltier elements, resistive heaters, and thermocouples. A temperature probe may be used to measure the temperature of a droplet and/or temperature-controlled portion of DMF device 110 and provide temperature measurements to controller 112 so that controller 112 can precisely control the temperature of the droplet temperature-controlled portion of DMF device 110 via the thermal control mechanism 124. As another example, magnets 122 may be, for example, permanent magnets and/or electromagnets. In the case of electromagnets, controller 112 may be used to control the electromagnets 122. That is, in some examples, controller 112 may be used to control the position and orientation of magnets 122. Further, with respect to DMF device 110, controller 112 may control droplet manipulation (i.e., droplet operations) by activating/deactivating droplet actuators 132. In other configurations of DMF system 100, the functions of controller 112, detection system 116 (e.g., illumination source 118 and optical measurement device 120), magnets 122, thermal control mechanisms 124, and/or any other instrumentation or components may be integrated directly into DMF device 110 rather than provided separately from DMF device 110.

Optionally, DMF instrument 105 may be connected to a network. For example, controller 112 may be in communication with a networked computer 160 via a network 162. Networked computer 160 may be, for example, any centralized server or cloud-based server. Network 162 may be, for example, a local area network (LAN), a wide area network (WAN), or a cellular network for connecting to the internet.

Further, DMF device 110 of DMF system 100 may include one or more electrode arrangements 130. Each of the electrode arrangements 130 may include, but is not limited to, any arrangements (e.g., lines, paths, arrays) of droplet operations actuators 132 (e.g., electrowetting electrodes). Droplet operations actuators 132, also referred to herein as droplet actuators, may be used to fluidly connect any arrangements of droplets and direct fluid to and from one or more reservoirs 134. Further, certain droplet operations actuators 132 may be designated as detection spots 136. In one example, illumination source 118 and optical measurement device 120 may be arranged with respect to detection spots 136 of DMF device 110. DMF device 110 may also comprise one or more reservoirs 134, which may be used to incorporate any fluid sources integrated with or otherwise fluidly coupled to DMF device 110. Reservoirs 134 may include any number and/or arrangements of, for example, on-cartridge reservoirs, off-cartridge reservoirs, blister packs, fluid ports, and the like, and any combinations thereof. Reservoirs 134 may be used to manage any liquids, such as reagents, buffers, sample volumes, and the like, needed to support any processes of DMF device 110. On-cartridge reservoirs 134, for example, may be formed of particular arrangements of droplet operations actuators 132.

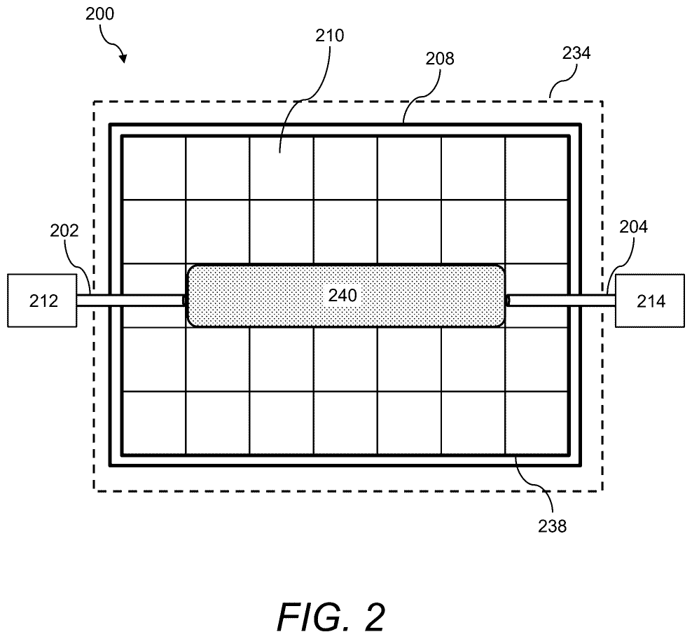

FIG. 2 illustrates a top view of an example digital microfluidics (DMF) actuator array (i.e., actuator arrangement) 238 in a DMF device or cartridge 200. DMF device 200 may be configured to electronically and/or mechanically engage and/or optically engage with a DMF instrument, such as DMF instrument 105 shown in FIG. 1. In one embodiment, a DMF instrument suitable for receiving DMF device 200 may comprise a recessed region sized to receive DMF device 200. In this way, DMF device 200 may be fluidly connected, optically connected, and/or electrically connected to the DMF instrument. Further, either or both the DMF instrument and DMF device 200 may include one or more features such as, for example, notches, that enable the accurate alignment and coupling of fluidic, optical, and electrical connections. In one embodiment, not shown, alignment may be enhanced by posts or openings in an optical fiber interface of DMF device 200 which mates with corresponding posts or openings in the DMF instrument, and/or by a variety of similar approaches that will be apparent to one of skill in the art.

With respect to optical coupling, DMF device 200 may comprise one or more optical fibers or one or more bundles of multiple optical fibers. Further, the optical fiber(s) may be multimode, single mode, or any combination of the two with multiple cores and/or cladding layers. DMF device 200 may also have one or several interfaces to allow for the coupling of one or more optical fibers to the DMF instrument. The optical interface(s) may be, for example, fiber optic connectors, fiber optic couplers, and/or free-space optical couplers. When DMF device 200 is loaded into the DMF instrument, the ends of each fiber in DMF device 200 may substantially align with, for example, one or more optical fibers leading to and/or from an illumination source or transmitting optical component and/or to an optical measurement device, detecting optical component, or detector. Alternatively, the optical fiber(s) may be a part of DMF instrument 105, entirely external to the DMF device 200, and may be engaged with DMF device 200 by being physically inserted into the DMF device 200.

In some embodiments, a DMF system (e.g., DMF device 200 and a DMF instrument) may include alignment elements to ensure that, when DMF device 200 is coupled to a DMF instrument, the fiber optic elements of the DMF instrument and DMF device 200 are optically coupled and/or aligned. For example, when DMF device 200 is inserted into a DMF instrument, the DMF instrument may automatically perform alignment steps to maximize coupling efficiency between the fibers in DMF device 200 and those in the DMF instrument. The DMF device 200 may also optionally include alignment elements to ensure that the optical elements within it are aligned to a correct detection spot within the actuator arrangement. It will be appreciated that a wide variety of mechanisms are possible for electrically and optically coupling DMF device 200 to a DMF instrument, such as DMF instrument 105.

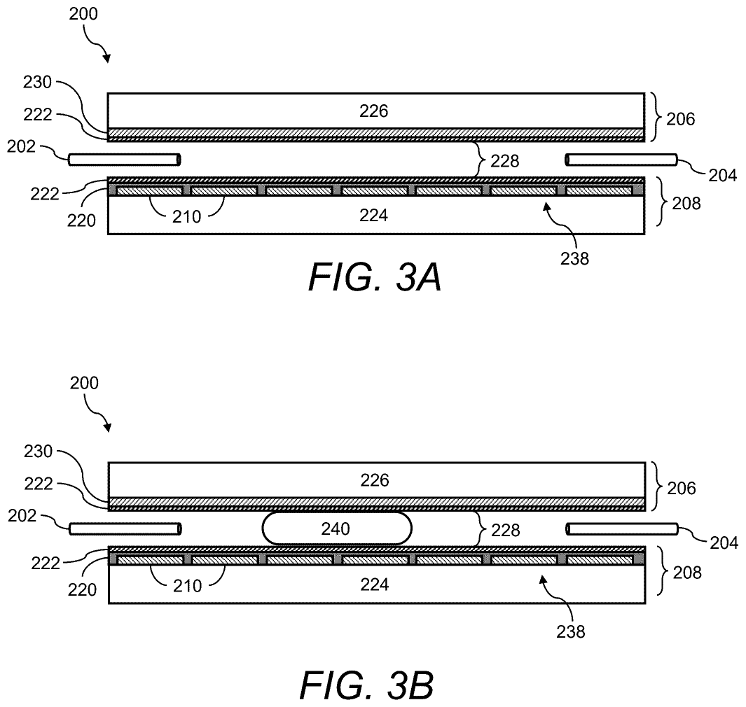

Still referring to FIG. 2, in an example, DMF device 200 generally comprises an actuator array (i.e., actuator arrangement) 238 and two optical fibers 202, 204 that are aligned in opposing directions, such that light transmitted from an input optical fiber 202 may be directed towards a receiving end of an output optical fiber 204. A droplet 240 may be positioned along a path length between input and output optical fibers 202, 204. Furthermore, DMF device 200 can include two parallel plates 206, 208 (shown in FIGS. 3A and 3B) with a droplet operations gap 228 positioned therebetween. Optical fibers 202, 204 are positioned in droplet operations gap 228 between top plate 206 (shown in FIGS. 3A and 3B) and bottom plate 208 (shown in FIGS. 2-3B). Top plate 206 and bottom plate 208 can include a hydrophobic coating 222 (shown in FIGS. 3A and 3B) to promote formation of droplet 240 in droplet operations gap 228, although it will be appreciated by a person of ordinary skill in the art that other DMF cartridge configurations are applicable for the present application, for example, the DMF cartridge may not have a top plate, as shown in United States Patent Publication No. 2023/0279512 A1 to Masters et al.

Actuation of droplet actuators 210 in actuator array 238 controls the placement and movement of droplet 240 in droplet operations gap 228. Droplet 240, in which an analyte may be dissolved, is generally an aqueous solvent system and may optionally contain one or more additional dissolved components including: salts, buffers, surfactants, proteins, nucleic acids, cells, beads, and fragments/sub-components of the like. Droplet operations gap 228 may also contain a filler fluid, such as a gas, air, or a liquid that is sufficiently immiscible with droplet 240 that it does not substantially interfere with the desired analytical process but enables droplet mobility on the actuator array 238. In some embodiments, the filler fluid may be an oil such as, for example, a silicon oil or fluorinated oil. Accordingly, the filler fluid may fill droplet operations gap 228 and surround droplet 240. Alternatively, the filler fluid may encapsulate the fluid droplet (i.e., oil-encapsulated droplet). See U.S. Pat. No. 11,623,219 B2 to Jebrail et al. Additionally, actuator array 238 can comprise any lines or paths of droplet actuators 210 that enable the movement of droplets 240 or droplet operations in droplet operations gap 228. The actuator array 238 may further be used to combine droplets 240 of various compositions for performing a particular experiment or assay. The length or dimension of each of the droplet actuators 210 of actuator array 238 may be from about 100 micrometers to about 2 millimeters, and droplet actuators 210 may be, for example, square, rectangular, hexagonal, triangular, parallelogram or a combination of several shapes. In some arrangements, the shape edges may be patterned such that the shapes interdigitate.

As shown in FIG. 2, input optical fiber 202 can be connected to one or more light sources 212 for providing light to droplet 240 in droplet operations gap 228. Output optical fiber 204 can receive light emitted from input optical fiber 202 through droplet 240 and can transmit the received light to be processed by a detector or detection system 214. That is, each optical fiber can transmit light from one end to the other and serves as an optical guide to transmit light from the light source 212 to droplet operations gap 228 and receive light from droplet operations gap 228 and transmit the light to detector 214. In some embodiments, each optical fiber may consist of a strand made of flexible glass or plastic fiber wrapped with a lower refractive index material such that light is confined within the fiber permitting transmission with low loss. In DMF device 200 as shown, one end of the input optical fiber 202 and one end of the output optical fiber 204 may be positioned so that each end is proximal to an edge of a respective droplet actuator 210. Aligning the ends of the optical fibers with edges of respective droplet actuators 210 ensures the path length between the fiber ends is known; however, the distance between optical fiber ends may be extrapolated by other means. The path length may be defined as the distance between the end of input optical fiber 202 and the end of the output optical fiber 204, which may either be the distance between optical guides, such as the optical fibers, but could also be the distance between the incident light source 212 and detector 214. In this example, the path length is fixed (i.e., the distance between optical fiber ends is fixed), but the path length may also be variable (i.e., the position of the optical fiber ends may be adjustable). Further, in some examples, the path length may be defined by the length of droplet 240. Additionally, DMF device 200 and the DMF instrument into which it couples are not limited to one light or illumination source 212 and one optical measurement device or detector 214, but may have more than one light source 212 and more than one detector 214 to support any detection modalities.

Generally, light source 212 can emit light of a single wavelength or multiple wavelengths and may be a broadband emitter. The incident light from light source 212 can be from, for example, an LED or a laser. DMF device 200 may include one or more optical guides which may include one or more optical fibers, mirrors, lenses, collimators, or other optical components that serve to guide light from light source 212 to droplet 240. Further, DMF device 200 may include one or more fenestrations that allow light to be transmitted from light source 212 to droplet 240. The fenestrations may be optically transparent portions of top plate 206 or bottom plate 208 that allow for the transmission of light from light source 212 to droplet 240. The fenestrations may have any shape or size. Light source 212 may emit light at any wavelength, for example, from about 200 nm to about 800 nm, but could be from 190 nm to 900 nm. In some embodiments, the DMF system can comprise a plurality of light sources 212 each of which is capable of emitting a different wavelength, wavelengths or plurality of wavelengths. For example, different analytes have different ideal light absorption and emission spectra, and an appropriate light source 212 can be selected for the analysis of a particular analyte in solution. Additionally, in some embodiments, the luminance of light source 212 can be modified or varied to provide a range of optical measurements through droplet 240.

Furthermore, generally, output optical fiber 204 can be connected to detector 214, which receives light transmitted through the fiber and measures the wavelength and intensity of the received light. More specifically, in some embodiments, detector 214 may be configured to detect light at the wavelength(s) emitted by the light source 212. As such, detector 214 may be any optical transducer device used to obtain, for example, light intensity readings. Detector 214 may be any type of optical measurement device, for example, a charge-coupled device (CCD), a photodetector, a spectrometer, a photodiode detector, a camera, a photomultiplier tube, phototube, other arrays or any combination thereof, and can be a monochromatic detector or polychromatic detector. DMF device 200 may include one or more optical guides which may include one or more optical fibers, mirrors, lenses, collimators, or other optical components that serve to guide light from droplet 240 to detector 214. Further, DMF device 200 may include one or more fenestrations that allow light to be transmitted from droplet 240 to detector 214. The fenestrations may be optically transparent portions of top plate 206 or bottom plate 208 that allow for the transmission of light from droplet 240 to detector 214. The fenestrations may have any size or shape.

In a DMF system, droplet 240 comprises one or more analytes and the DMF system can be designed to analyze the composition and concentration of the analytes. Droplet 240 may comprise chemical, biochemical, or biological components, which can be, for example, biological molecules such as nucleic acids and proteins, or dissolved organic molecules, which are collectively referred to herein as analytes. Other types of molecule analytes that can be detected include, but are not limited to, biomolecules selected from the group consisting of antibodies, antibody fragments, recombinant proteins, oligonucleotides, lipids, small molecules, viruses and virus-like particles (VLP), and whole cells. In one example, droplet 240 may be a crude biological sample, such as, for example, a droplet of blood (or fraction thereof), droplet of saliva, or droplet of another biological sample to be evaluated. In another example, droplet 240 may be a reagent droplet for conducting an assay. In yet another example, droplet 240 may be a reaction droplet that may or may not include a target analyte of interest.

Beer-Lambert law, also referred to commonly as Beer's law, can be used to measure the concentration of chemical, biochemical, or biological species that absorb light in a fluid. Beer's law provides that the amount of absorbed or scattered light in a fluid, or reduction in transmittance compared to the initial light intensity, is relative to the amount of dissolved analyte in the fluid. In particular, Beer's law provides that for directional or collimated light passing through a solution of uniform concentration, the absorbance of light in the solution is proportional to the path length of the light through the solution. In spectrophotometry, absorbance can be measured using Beer's law as a ratio of the intensity of light transmitted through a sample of interest relative to the intensity of light traveling through a blank sample along a standard path length:

$$Absorbance = - {log}_{10} ( T ) = - {log}_{10} ( {I}_{R} / {I}_{0} ) = ɛ \cdot ℓ \cdot c$$

where:
T is the transmittance or amount of light received at a sensor;
I_{R} is the intensity (e.g., power) of light transmitted through the sample being measured;
I₀ is the intensity of light transmitted through a blank or reference sample;
[symbol] is the path length;
c is the concentration; and
ε is the molar extinction coefficient.

In DMF device 200, by measuring the intensity of light transmitted (I₀) by light source 212 through input optical fiber 202 received at output optical fiber 204 and transmitted to detector 214 in a blank or reference droplet 240 (i.e., droplet 240 without analyte) compared to the intensity of light transmitted (I_{R}) by light source 212 through input optical fiber 202 received at output optical fiber 204 and transmitted to detector 214 in a sample droplet 240 (i.e., droplet 240 with analyte), the concentration of an analyte in the sample droplet 240 can be determined.

Another way of measuring the concentration of an analyte in a solution uses the absorptivity of an analyte in a solvent in which it is dissolved at a particular wavelength of interrogating light from a light source. In this case, the concentration of the analyte in solution can be calculated based on the optical path length of the light through the solution, the absorbance of the solution containing the analyte, and the absorptivity of the analyte:

$$c = \frac{A}{ɛ \cdot ℓ}$$

where:
c is the concentration of the analyte in solution;
A is the absorbance;
ε is the molar absorptivity of the analyte; and
[symbol] is the optical path length.

In DMF device 200, the optical path length can be controlled and the distance between the boundaries of droplet actuators 210 is known. Therefore, the concentration of an analyte in droplet 240 can be accurately measured using the above equation if the molar absorptivity of the analyte is known.

Further, droplet actuators 210 in DMF device 200 are capable of changing the shape and orientation of droplets 240 on the actuator array 238, thereby modifying the path length between the input optical fiber 202 and output optical fiber 204. By changing the path length of the light between the input optical fiber 202 and the output optical fiber 204 through droplet 240, multiple measurements can be taken from a single droplet 240. This enables a calibration curve to be generated from a single solution having a known concentration. Further, multiple measurements of the same solution can be collected at different path lengths and the results averaged to provide a more accurate measurement.

DMF device 200 may use a low volume droplet 240, for example, droplet 240 may be 100 picoliters (pL) or more, less than about 1000 nanoliters (nL), or less than about 900 nL, or less than about 800 nL, or less than about 700 nL, or less than about 600 nL, or less than about 500 nL, or less than about 400 nL, or less than about 300 nL, or less than about 200 nL, or less than about 100 nL. In some embodiments, the present system can provide accurate measurement of analyte concentration in droplet 240 in the nanoliter range.

DMF device 200 and other similar devices may also be used, for example, in Surface Plasmon Resonance (SPR) assays, such as biomolecular interaction assays including molecular library screening assays, binding kinetics assays, affinity determination assays, binding site mapping assays, competition analysis assays, specificity determination assays, and characterizations of antibody binding.

DMF device 200 may also comprise capacitive feedback sensing, for example, a signal coming from a capacitive sensor that can detect droplet position and volume. Instead of or in addition to capacitive feedback sensing, DMF device 200 may be connected to a camera to provide an optical measurement of the position and volume of droplet 240. Capacitive and/or camera feedback can also be used to trigger a controller (such as controller 112 of DMF system 100 of FIG. 1) to re-route droplets 240 at appropriate positions and to particular droplet actuators 210 on actuator array 238.

Referring now to FIGS. 3A and 3B, FIG. 3A illustrates a side cross-sectional view of one embodiment of a digital microfluidics (DMF) actuator array 238 in a DMF device 200 and FIG. 3B illustrates a side cross-sectional view of a digital microfluidics (DMF) actuator array 238 in a DMF device 200 with a droplet 240 in the droplet operations gap 228. As shown, top plate 206 and bottom plate 208 are spaced apart to define droplet operations gap 228 therebetween. Top plate 206 can include a substrate 226 with one or more layers or coatings, such as ground or reference 230 and hydrophobic coating 222. Bottom plate 208 can include a substrate 224 with actuator array 238, including droplet actuators 210, and one or more layers or coatings, such as a dielectric layer 220 and a hydrophobic layer 222. Additionally, in some embodiments, DMF device 200 may include a cover plate disposed over top plate 206 and bottom plate 208 which serves to protect the device components and provide support to the whole of DMF device 200.

Still referring to FIGS. 3A and 3B, two optical fibers are shown inside the droplet operations gap 228, one input optical fiber 202 and one output optical fiber 204, connected with a light or illumination source 212 and a light detector 214, respectively (not shown in FIGS. 3A and 3B). The example DMF device 200 shown has bottom substrate 224 and facing top substrate 226 separated by droplet operations gap 228, although it will be appreciated by a person of ordinary skill in the art that other DMF device configurations are applicable for the present application, for example, the DMF device may not have a top substrate as shown in United States Patent Publication No. 2023/0279512 A1 to Masters et al. As noted above, droplet operations gap 228 may be filled with a filler fluid, such as a gas (e.g., air or inert gas) or a liquid that is sufficiently immiscible with droplet 240 that it does not substantially interfere with the desired analytical process. In one embodiment, the filler fluid is a low-viscosity oil, such as, for example, silicone oil, fluorinated oil or hexadecane. In some applications, it may be advantageous if the filler fluid refractive index is closely matched to the medium of the analyte. For example, if the medium is substantially aqueous, a filler fluid with a refractive index of about 1.33 would minimize any light scattering off of the analyte/filler fluid interface. An arrangement of droplet actuators 210 (e.g., electrowetting electrodes) may be provided atop bottom substrate 224.

DMF device 200 can comprise any lines or paths of droplet actuators 210 that enable movement of one or more droplets 240 or droplet operations in droplet operations gap 228. Additionally, in some embodiments, dielectric layer 220 may be provided atop droplet actuators 210, which can be, for example, a parylene coating, or silicon nitride coating a polyimide coverlay, fluorinated ethylene propylene (FEP), glass, or a metal oxide layer. A hydrophobic layer 222 may be provided over dielectric layer 220 and other portions of bottom substrate 224, as well as portions of top substrate 226 including a surface facing droplet operations gap 228 to confine and provide surface tension to droplet 240 in droplet operations gap 228. In some devices, if dielectric layer 220 is suitably hydrophobic, it may function as both dielectric layer 220 as well as hydrophobic layer 222. In some embodiments, a ground or reference 230 in top plate 206 grounds droplet actuators 210 in actuator array 238 in bottom plate 208. In other embodiments, such as when DMF device 200 does not have a top plate, ground or reference 230 may be included in bottom plate 208.

One or more input optical fibers 202 may be positioned within droplet operations gap 228, i.e., between top plate 206 and bottom plate 208 of DMF device 200 to allow light from a light source (e.g., light source 212 illustrated in FIG. 2) to reach droplet 240. At the same time, one or more output optical fibers 204 may be positioned in within droplet operations gap 228 and may be used to transmit light from the droplet 240 in droplet operations gap 228 to a detector (e.g., detector 214 illustrated in FIG. 2). In some embodiments, the optical fibers 202, 204 may be positioned in the top and/or bottom plate 206, 208. In some embodiments, the optical fibers 202, 204 may be external to DMF device 200 and physically inserted through apertures in DMF device 200. In some embodiments, either the light source and/or the detector may be integrated within DMF device 200, and in this case, optical fibers 202, 204 may or may not be used. The light source and/or detector may either be positioned in droplet operations gap 228 or on top plate 206 or bottom plate 208. In some embodiments, a light source such as one or more light-emitting diode (LED) may be integrated within droplet operations gap 228 or on top plate 206 or bottom plate 208. In some embodiments, a photodiode array may be integrated within droplet operations gap 228 or on top plate 206 or bottom plate 208. DMF device 200 may also comprise multiple inputs and outputs to and from DMF device 200 to allow for multiple analyses to occur simultaneously.

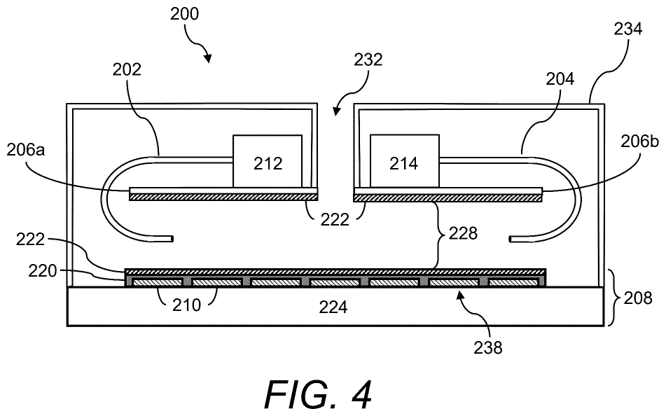

According to another example, FIG. 4 illustrates a side cross-sectional view of a digital microfluidics (DMF) actuator array 238 and a spectrochemical detection device comprising an illumination light source 212, light detector 214, and light transmitting fibers 202, 204 therebetween positioned inside a droplet operations gap 228. DMF device 200 has a bottom plate 208 which may be, for example, a silicon substrate or a printed circuit board (PCB). More specifically, bottom plate 208 may include a bottom substrate 224 connected to an arrangement of droplet actuators 210 (e.g., electrowetting electrodes) and dielectric layer 220. In some embodiments, droplet actuators 210 may be formed, for example, of copper, gold, or aluminum, or other conducting material.

Dielectric layer 220 (e.g., parylene coating, silicon nitride, polyimide, glass) may be atop droplet actuators 210. In the present embodiment, a top substrate is bifurcated into top plate 206a, 206b, which may include, for example, a glass or plastic substrate that is also coated with a dielectric layer (not shown). The bifurcated top plates 206a, 206b in this embodiment have one or more fluid apertures 232 therebetween to enable the transfer of fluid into droplet operations gap 228. That is, fluid aperture 232 provides fluid access to the fluidic chamber defined by droplet operations gap 228. Top plates 206a, 206b may also comprise one or more ground or reference layers (not shown), similar to ground of references 230 illustrated in FIGS. 3A and 3B. In one example, the ground or reference 230 may be formed of indium tin oxide (ITO) and wherein ITO is substantially transparent to light. Further, a hydrophobic layer 222 may also be provided on one or both of the surface and sides of bottom plate 208 and on one or both of the surface and sides of top plates 206a, 206b that is configured to face droplet operations gap 228. Examples of hydrophobic materials or coatings may include, but are not limited to, polytetrafluoroethylene (PTFE), Cytop, Teflon™, amorphous fluoropolymer (AF) resins, FluoroPel™ coatings, silane, and the like.

Droplet operations may be conducted on top of the actuator array 238 comprising droplet actuators 210 on a droplet operations surface. For example, in use, a droplet 240 (not shown in FIG. 4) may be present in droplet operations gap 228 of DMF device 200 and the droplet 240 may be moved around and positioned at different portions of the actuator array 238 via droplet operations. The DMF device 200, together with the droplet actuators 210 of the actuator array 238, may be used to form any arrangements (e.g., lines, paths, arrays) of droplet actuators 210. Input optical fiber 202 is connected to light source 212, which provides illumination through input optical fiber 202 to a location in droplet operations gap 228, which is the space between hydrophobic layer 222 on bottom plate 208 and hydrophobic layer 222 on bifurcated top plates 206a, 206b. Output optical fiber 204 is aligned with input optical fiber 202 such that it receives light from the end of input optical fiber 202 and transmits it to detector 214. In an absorbance measurement of a droplet 240 in the droplet operations gap 228, the droplet 240 may be positioned between the terminus of input optical fiber 202 and the terminus of output optical fiber 204, having a known distance between them, such that the transmission or absorption of light through the droplet 240 can be measured and a concentration of analyte in the droplet 240 can be determined. The DMF device 200 can also comprise a cover plate 234 for protecting the components and fluid therein and for providing structural rigidity to DMF device 200.

In some embodiments, droplet operations gap 228 can be approximately 300 μm, the bottom plate thickness approx. 1 mm; top plate thickness approx. 1 mm; fiber diameter approx. 200 μm; electrode approx. 1000 μm×1000 μm, can be any shape including square and rectangular.

In other embodiments, DMF device 200 can comprise additional optical fibers together with one or more LSPR (localized surface plasmon resonance) sensors (not shown) also arranged in droplet operations gap 228. Accordingly, any droplet 240 in the droplet operations gap 228 may also come into contact with an LSPR sensor using droplet operations.

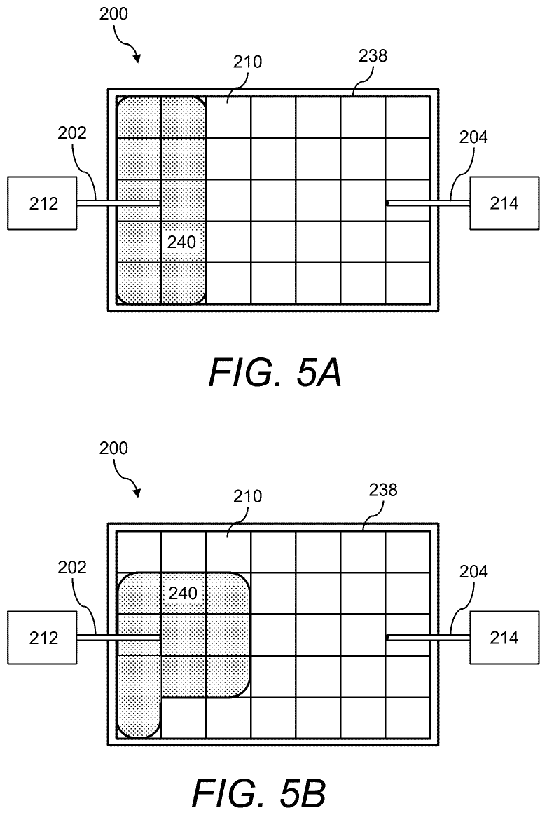

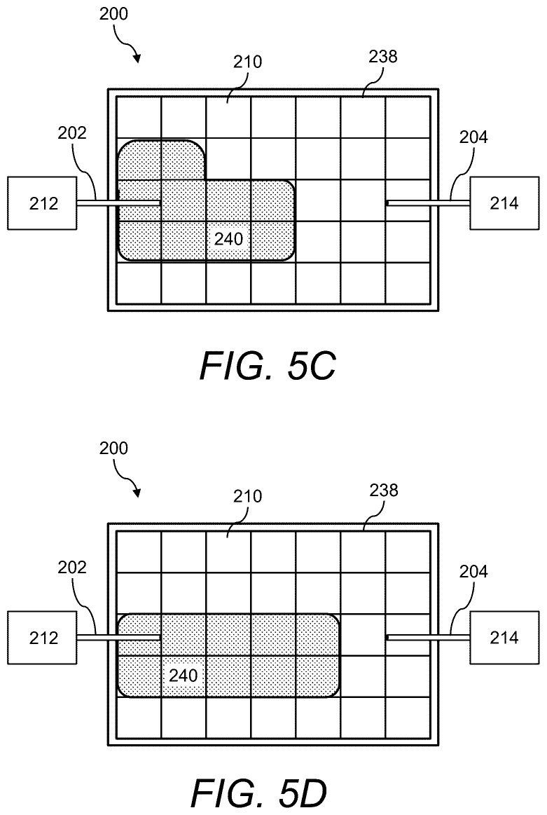

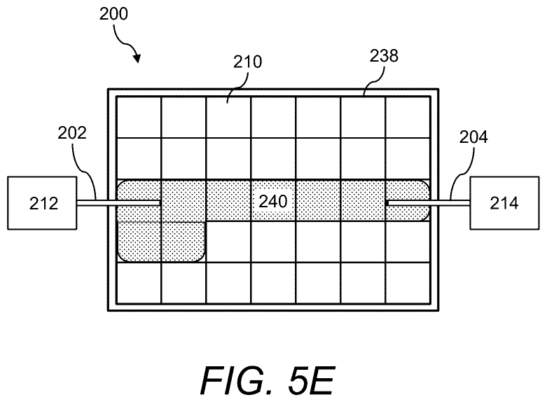

FIGS. 5A-5E illustrate atop view of DMF actuator array 238 with a droplet 240 stretched over multiple droplet actuators 210 in a variety of different configurations in a DMF device 200. As shown, droplet 240 may have a volume that occupies the surface area of multiple droplet actuators 210 in droplet operations gap 228. By moving the droplet 240 around using droplet operations control of the droplet actuators 210, the shape and orientation of droplet 240 can be modified on the actuator array 238 to change the shape of droplet 240. This can thereby change the optical path length of light through the droplet 240 between the end of input fiber 202 where light is directed from light source 212 to the end of output optical fiber 204 where light is received and sent to detector 214. Controlling the sequential stretching and reshaping of droplet 240 over multiple actuators 210 shaped by the layout of actuated droplet actuators 210 using an applied electric field provides a controllable and variable optical path length through droplet 240 which may contain the analyte of interest. The remaining space in the droplet operations gap 228 that is not occupied by droplet 240 can be filled with a filler fluid. Alternatively, droplet 240 may be encapsulated with a filler fluid (e.g., oil-encapsulated droplet) In various embodiments, the ends of input fiber 202 and output fiber 204 are aligned so that they are adjacent to or in proximity with a respective droplet actuator 210. In various embodiments, the ends of input optical fiber 202 and output optical fiber 204 are aligned so that each end is aligned with an edge droplet actuator 210.

In some applications, measurements of the light absorbance by the filler fluid at the wavelength of the light source 212 through different optical path lengths of the filler fluid can be used to subtract any effect of the filler fluid on light transmission from input optical fiber 202 to output optical fiber 204 to determine the absorbance of light only through the droplet 240. In addition, the contribution of any components in the droplet 240 that may affect light absorbance can be subtracted by performing a pre-calibration measurement of the droplet 240 without the analyte of interest.

In FIG. 5A, the optical path length through droplet 240 between the ends of input optical fiber 202 and output optical fiber 204 is equivalent to the length of one droplet actuator 210, and the contribution of a reduction in light transmittance through the filler fluid, here equivalent to the length of four droplet actuators 210, can be subtracted. In FIG. 5B, by changing the droplet shape using droplet operations via droplet actuator 210 on actuator array 238, the optical path length through droplet 240 between the ends of input optical fiber 202 and output optical fiber 204 can be changed to be the length of two droplet actuators 210. In FIG. 5C, the optical path length through droplet 240 between the ends of input optical fiber 202 and output optical fiber 204 is the length of three droplet actuators 210, as droplet 240 has been manipulated into an L-shape on the actuator array 238. In FIG. 5D, the optical path length is now the equivalent to four droplet actuator lengths, and in FIG. 5E the optical path length is now the equivalent to five droplet actuator lengths. As understood from the Beer-Lambert law, the light absorbance through a medium is dependent on the optical path length of the light through that medium. By changing the optical path length of droplet 240 in a DMF system, the absorbance of light through various path lengths of the same droplet can be obtained, providing a determination of the concentration of analyte in droplet 240.

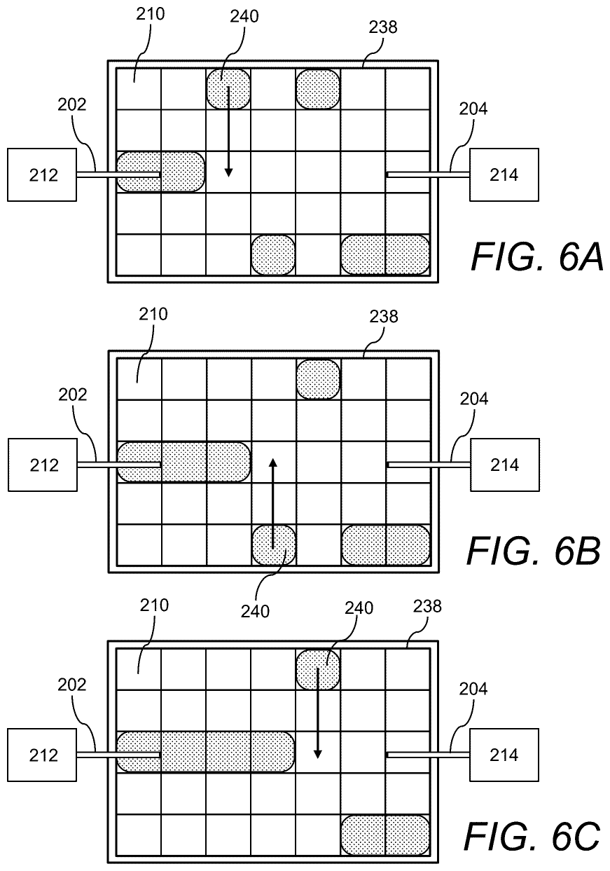

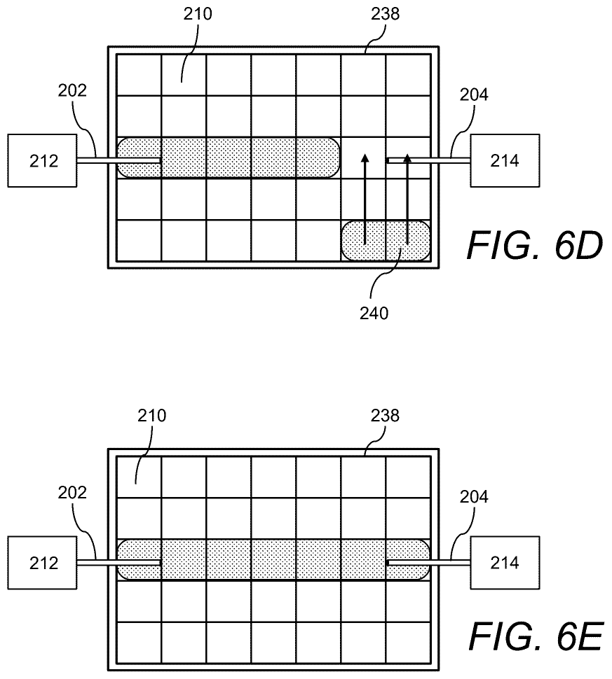

FIGS. 6A-6E illustrate top views of a DMF actuator array 238 in a DMF system, corresponding to a method of moving droplets 240 around on the actuator array 238. As shown in FIG. 6A, a droplet 240 in the first row and third column of the actuator array 238 can be moved or transposed down such that it is combined with a droplet 240 in the third row. This actuation changes the volume of each droplet 240 and also the optical path length of light traveling through the droplet 240 between input optical fiber 202 and output optical fiber 204. Similar movements of droplets 240 are shown in FIGS. 6B-6E, wherein, in FIG. 6E, all droplets 240 have been aligned between input optical fiber 202 and output optical fiber 204. The emission of light from light source 212 through input optical fiber 202 is transmitted through the droplet 240 and received by output optical fiber 204, which is detected by detector 214. In this way, droplets 240 can be added together, stretched, replaced, or combined, one or more at a time, to provide an optical path length through the droplet 240 from one length of one droplet actuator 210 up to the full distance between the end of input optical fiber 202 and the end of output optical fiber 204.

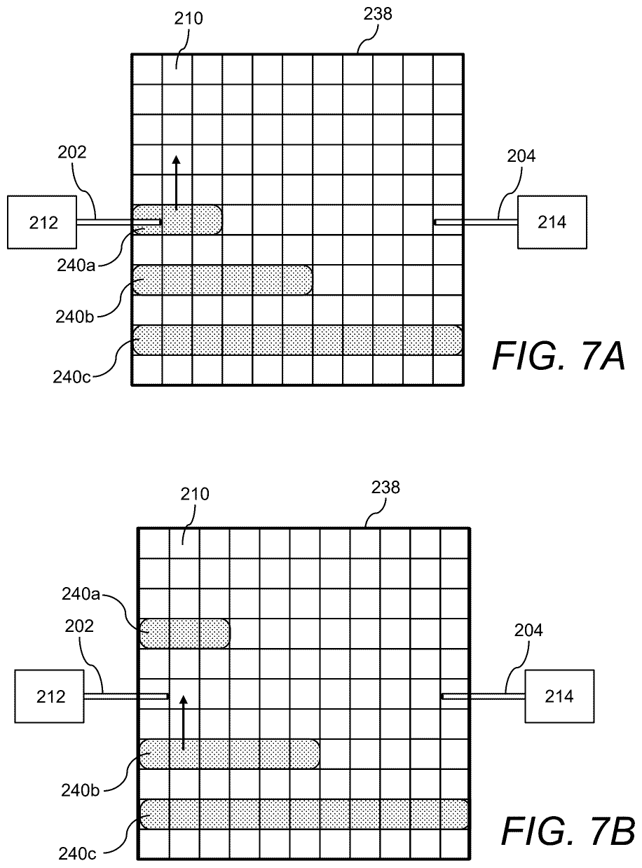

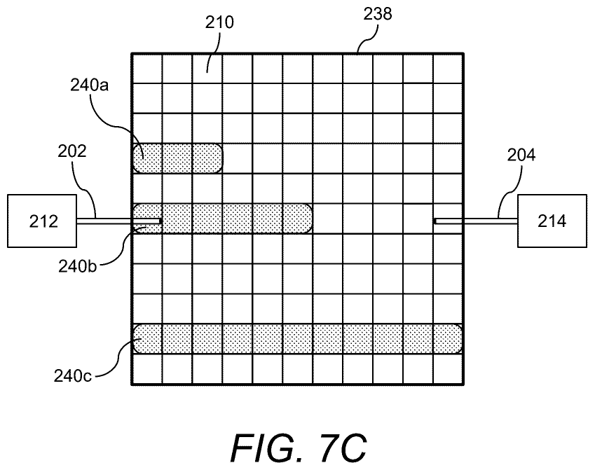

FIGS. 7A-7C illustrate top views of a DMF electrode array 238, corresponding to another method of moving and replacing multiple droplets around on the electrode array 238. As shown, droplets 240a, 240b, 240c can be moved around electrode array 238 by actuation of droplet actuators 210 (e.g., actuation electrodes). Placement of a droplet 240 between the ends of input optical fiber 202 and output optical fiber 204 enables measurement of the absorbance of light from light source 212 by the droplet 240, which is detected by detector 214. By changing the orientation and placement of each droplet 240a, 240b, 240c between the ends of input optical fiber 202 and output optical fiber 204 the path length of light traveling through the respective droplet 240a, 240b, 240c can be changed, which changes the amount of light received by the detector based on the concentration of analyte in each droplet 240a, 240b, 240c. The droplets 240a, 240b, 240c shown can comprise the same or different analyte at the same or different concentration.

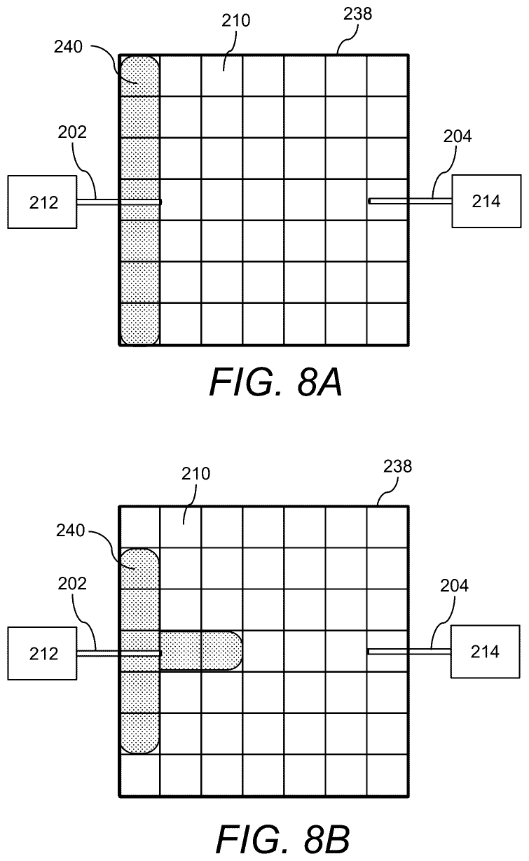

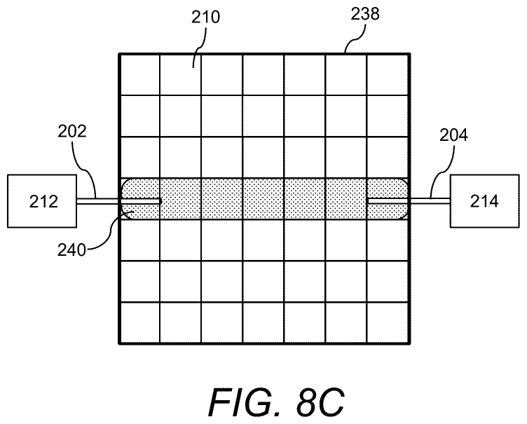

FIGS. 8A-8C illustrate top views of a DMF electrode array 238, corresponding to another method of moving and stretching multiple droplets around on the array to change the optical path length of the droplet 240 between input optical fiber 202 and output optical fiber 204. In FIG. 8A there is no droplet 240 between input optical fiber 202 and output optical fiber 204, enabling a measurement to be taken of only the filler fluid in the DMF cartridge 200 with an optical path length of the equivalent of five electrode actuator lengths. In FIG. 8B, the reduction in light transmission from light source 212 to detector 214 will be a result of the absorbance of two droplet actuator lengths of droplet 240 and three droplet actuator lengths of filler fluid, as measured between the end of input optical fiber 202 and the end of output optical fiber 204. In FIG. 8C, the reduction in light transmission will be a result of the absorbance of five electrode lengths of droplet 240.

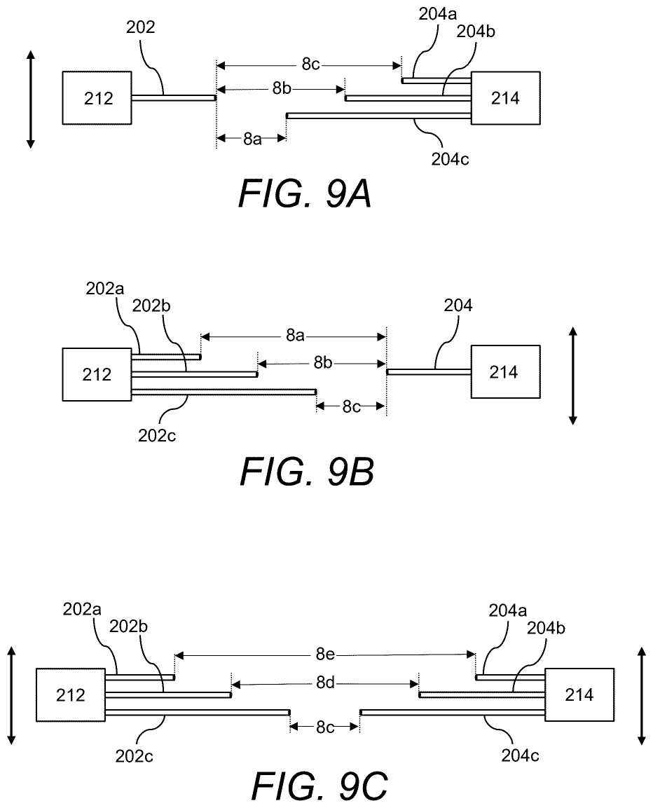

FIGS. 9A-9C illustrate an embodiment of a light source 212 or spectrophotometer 214 with multiple optical fibers 202, 204 such that there are several different path lengths between the input and output optical fibers 202, 204 which can be changed by actuating a droplet 240 between each pair (i.e., input and output) of optical fibers. For example, with directional reference to the views in FIGS. 9A-9C, by actuating a vertical location of either or both of light source 212 and detector 214, input optical fiber 202 and output optical fiber 204 can be optically aligned to change the path length between optical fibers 202, 204. By changing the distance or path length between input optical fiber 202 and output optical fiber 204, the path length through a droplet 240 can be changed, thus changing the absorbance or transmission between the optical fibers 202, 204.

In FIG. 9A, detector 214 has multiple output fibers 204a, 204b, 204c which can be aligned with a single input fiber 202 from light source 212 by translating the combination of light source 212 and input fiber 202. This results in path lengths 8a, 8b, and 8c. In FIG. 9B, detector 214 has a single output fiber 204 which can be aligned with one of multiple input fibers 202a, 202b, 202c connected to light source 212 by moving detector 214 and output fiber 204, resulting in path lengths 8a, 8b, and 8c. In FIG. 9C, detector 214 has multiple output fibers 204a, 204b, 204c which can be aligned with multiple input fibers 202a, 202b, 202c from light source 212, resulting in path lengths 8c, 8d, and 8e. Detector 214 and light source 212 movements or translations can be done using, for example, a stepper motor and a linear rail.

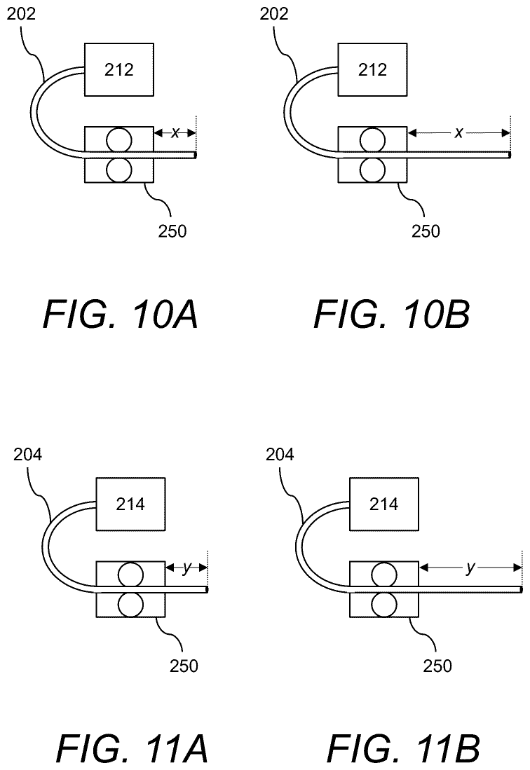

FIGS. 10A and 10B illustrate a light source 212 with an adjustable input optical fiber 202 in a retracted and extended configuration, respectively. More specifically, FIG. 10A shows the input optical fiber 202 in a retracted position and FIG. 10B shows the input optical fiber 202 in an extended position. Adjustment of the extension or retraction of input fiber 202 in droplet operations gap 228 in a DMF cartridge 200 enables changing an extension distance x between the end of input fiber 202 and the end of an output fiber connected to a light detector, and such adjustments can be used to change the path length of light through a droplet 240 in the DMF cartridge 200. In one embodiment, a fiber actuator 250 can include a mechanical mechanism or motor for extending and retracting input optical fiber 202, such as, for example, a linear actuator. The movement imposed by fiber actuator 250 may also be fine tune using incremental stops which define a specific path length. In an embodiment, the optical fiber 202 and optical fiber actuator 250 may be external to the DMF device 200 and are physically inserted into the device 200 to interact with droplet 240.

FIGS. 11A and 11B illustrate a light detector 214 with an adjustable output optical fiber 204 in a retracted position (FIG. 11A) and extended position (FIG. 11B). Adjustment of the extension or retraction of the output fiber attached to a light detector 214 in droplet operations gap 228 in a DMF cartridge 200 enables changing the extension distance y between the end of output fiber 204 and the end of an input fiber connected to a light source, and such adjustments can be used to change the path length of light through a droplet 240 in the DMF cartridge 200. It is understood that both input fiber 202 and output fiber 204 can be attached to a fiber actuator 250 to extend or retract the respective fiber 202, 204 in the droplet operations gap 228 in DMF cartridge 200.

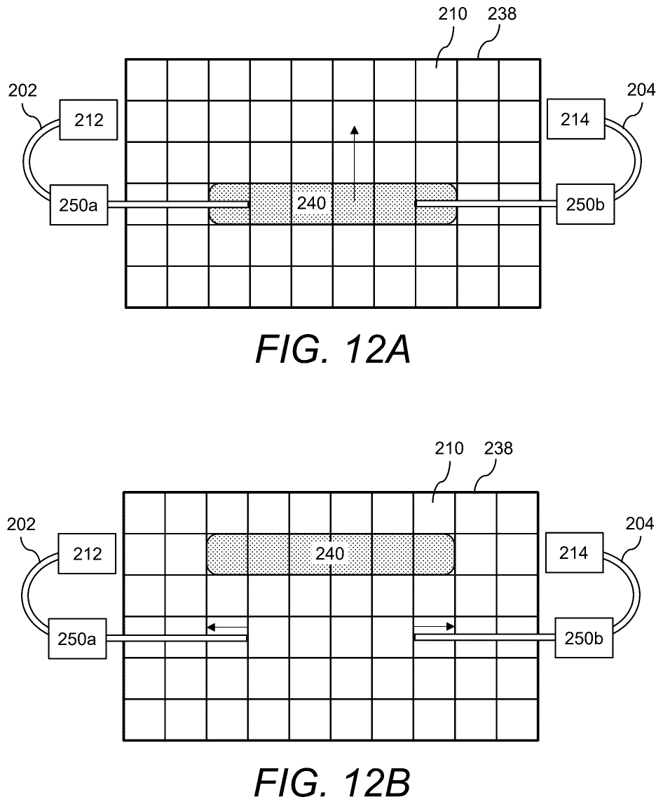

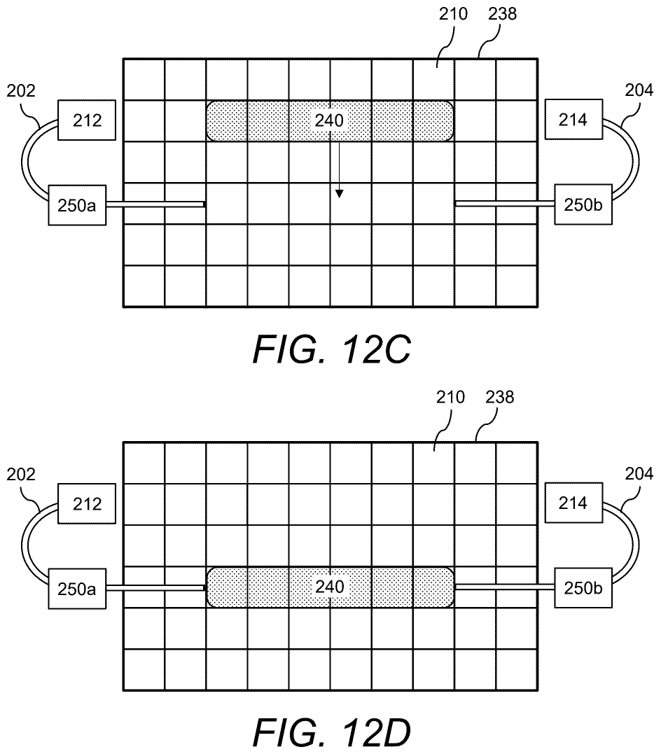

For example, FIGS. 12A-12D illustrate top views of a DMF actuator array 238, corresponding to another method of droplet repositioning with a light source 212 and detector 214 with adjustable input and output optical fibers 202, 204. In FIG. 12A droplet 240 is positioned between the ends of input optical fiber 202 and output optical fiber 204 connected to light source 212 and detector 214, respectively. The optical path length through droplet 240 has a distance equivalent to the length of four actuation electrodes 210 at this first optical path length. By actuating the distance between the ends of input optical fiber 202 and output optical fiber 204 in droplet operations gap 228 using fiber actuators 250a, 250b, the optical path length through droplet 240 can be changed, which will change the absorption of the light through the droplet 240 and, hence, the light received at detector 214. In FIG. 12B, by controlling droplet actuator 210 in actuator array 238, droplet 240 can be moved into a position away from input optical fiber 202 and output optical fiber 204. In FIG. 12C, fiber actuators 250a and 250b retract input optical fiber 202 and output optical fiber 204, increasing the distance between the end of input optical fiber 202 and the end of output optical fiber 204 from four droplet actuator lengths to six droplet actuator lengths. In FIG. 12D, droplet 240 is repositioned between input optical fiber 202 and output optical fiber 204 and now has a second optical path length of the equivalent of six droplet actuator lengths. Based on the exact path length, e.g., as calibrated for the actuator array 238, the concentration of an analyte can be calculated based on the absorbance at the first optical path length and the second optical path length. This process may be repeated for multiple path lengths to provide greater measurement accuracy.

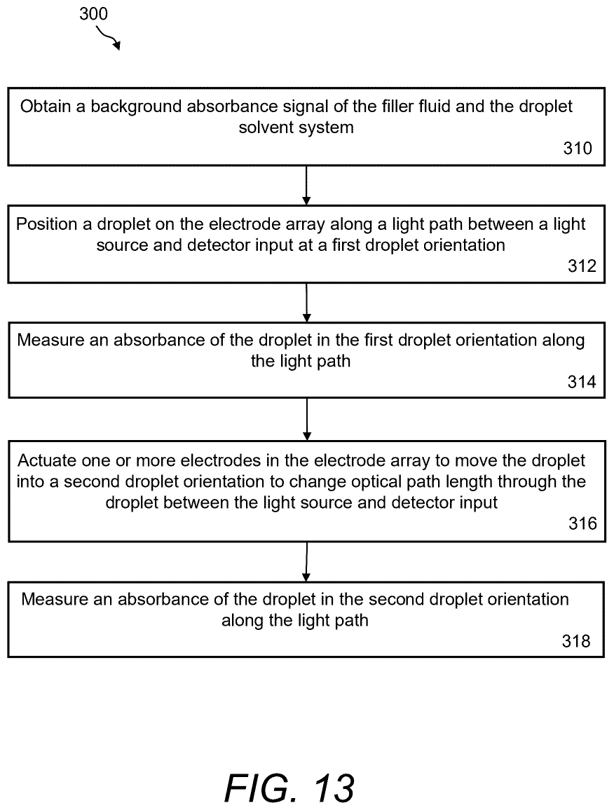

FIG. 13 is a flowchart illustrating one example method 300 for determining a concentration of analyte in a solution using spectrophotometry in a microfluidic system with a defined path length, such as any of the associated DMF system embodiments described herein or another suitable system. A background signal is obtained for the filler fluid or oil phase and also for the solvent system used in the droplet in which the analyte is dissolved (step 310). The measured background signals will be removed from the absorbance spectrum, and measurement of the background for the filler fluid and droplet solvent system can essentially zero out the system. Solvents used to form the droplet can also contribute to the background signal, which can comprise compounds that will absorb light but are not the analyte (or sample of interest).

More specifically, at step 310, to obtain the background signal of the droplet solvent system the absorbance measurement of a “dummy droplet” (or blank or reference), comprising only the solvent system used in the experiment, at one or more optical path lengths through the droplet can be obtained to determine the effects of droplet modulation and displacement of the oil phase on the absorbance signal. Similarly, one or more optical path lengths through the filler fluid can be obtained to determine the baseline or background of the filler fluid to determine the effect of the filler fluid on absorbance, which can be negated from the measurement of the absorbance caused by the presence of analyte in a droplet. The filler fluid or oil phase in the assay cartridge acts as a background, and movement of the droplet displaces the filler fluid along the path length. In some applications, the filler fluid or oil phase is optically transparent, or as optically transparent as possible, to allow for limited interference in the transmission of light between the light source and the detector through the filler fluid.

A first droplet is then positioned on the electrode array in a first droplet orientation along a light path between a light source and a detector input (step 312). The droplet volume may be, for example from about 100 picoliters to about 10 microliters in volume. The absorbance value of the droplet in the first droplet orientation can then be measured (step 314). The droplet size, shape, or orientation on the electrode array can then be changed to change the optical path length through the droplet along the light path between the light source and the detector input. To change the optical path length through the droplet between the light source and detector input, the droplet can be stretched across two or more actuators in the actuator array so that the droplet is positioned in a second droplet orientation on the actuator array. For example, one or more droplet actuators in the actuator array can be actuated to move the droplet into a second droplet orientation to change the optical path length through the droplet between the light source and detector input (step 316). The absorbance value of the droplet in the second droplet orientation can then be measured (step 318). This process (e.g., at least steps 316 and 318) may be repeated at various droplet orientations to provide an absorbance profile for the analyte in the droplet.

The absorbance measured in the droplet can be indicative of, for example, an analyte in solution, a reaction intermediate, a reaction probe, a reaction by-product, or a reaction product, depending on the reaction or solution being measured. In one example, the absorbance of a dye can be measured that is reactive to the concentration of the analyte. Typically, the dye or indicator may be used in cases where a monochromatic detector is used and the maximum light absorbed, or lambda max (λₘₐₓ) for the sample is outside the range of the detector. This process can also use different droplets such that a first droplet is provided, measured, and then a second droplet is provided and combined with the first to form a new droplet. This new droplet would occupy the space of two droplets such that the optical path length of the light from the light source to the detector is effectively doubled. Alternatively, the second droplet could replace the first droplet. In this case, the first droplet may not have a large enough sample volume to be stretched over the desired path length and, thus a second larger volume droplet could be provided.

In the present measurements, the concentration of analyte in the droplet(s) is generally unknown. However, the optical path length of light through the droplet is known from the electrode specifications and droplet orientation, the molar absorption coefficient of the analyte or substance whose absorbance is being measured is known. Based on the measurement of the actual light absorbance through the droplet, the concentration of analyte in solution can be discerned. It is understood that measurement of the absorbance in a droplet may be preferred in a well-mixed system and, thus, the droplets can be mixed, for example, by being moved around on the actuator array, between measurements, or during measurements. This can also be accomplished by iteratively actuating adjacent droplet actuators. Mixing can also be done in a linear or other geometric fashion along the path length. In the case where the method is performed in an air-matrix DMF device, for example, where there is no oil phase in the cartridge, then the background signal may be from air which acts as the filler fluid within the cartridge.

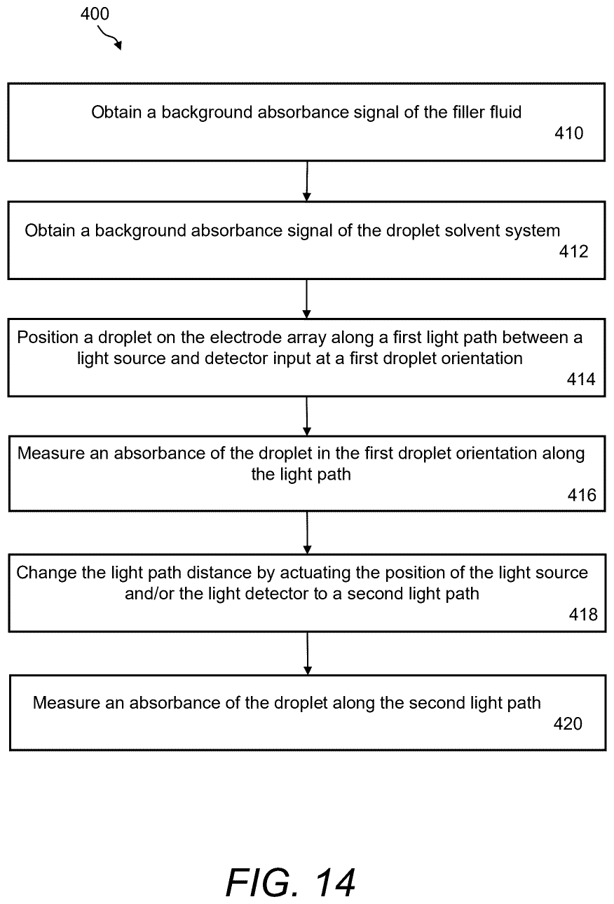

FIG. 14 is a flowchart illustrating one example method 400 for determining a concentration of analyte in solution using spectrophotometry in a microfluidic system with a variable path length, such as any of the associated DMF system embodiments described herein or another suitable system. First, a background signal is taken of the filler fluid which will be removed from the absorbance spectrum and essentially zeros out the system (step 410). A background signal is also taken of the droplet solvent system which will also be removed from the absorbance spectrum (step 412). The measured background signals can be removed from the absorbance spectrum such that the absorbance measured through a droplet containing the analyte will be due to the analyte in the droplet. The background signals for the filler fluid and droplet solvent system can be measured at one or more optical path lengths through the filler fluid and droplet solvent system to determine the effects of the filler fluid and droplet solvent system on the absorbance signal along the optical path between the light source and the detector.

A first droplet is then positioned on the actuator array at a first droplet orientation along a light path between a light source and detector input (step 414). The droplet volume may be, for example, from about 100 picoliters to about 10 microliters in volume. The absorbance value of the droplet in the first droplet orientation can then be measured (step 416) at a first path length in the droplet operations gap.

The optical path between the position of the light source and the position of the detector element that receives light through the droplet, which is optionally an optical fiber, will change the distance of the path length. To do this, the position of the light source and/or the detector is actuated in the droplet operations gap to change the path length (i.e., distance of optical path) to a second path length (step 418). This changes the path length between the light source and the detector in the cartridge. Additionally, the path length through the droplet between the light source and detector input can also be changed by the actuation of one or more droplet actuators in the actuator array to change the orientation of the droplet along the optical path. The absorbance value of the droplet in the second path length orientation can then be measured (step 420). This process may be repeated at various path length orientations to provide an absorbance profile for the analyte in the droplet solution.

Accordingly, in the present method of FIG. 14, either or both of the light source or the detector input can be modular such that it can be moved or actuated to adjust the path length (or optical path), and the droplet may be relaxed from a stretched position (i.e., transitioned from being positioned over one droplet actuator to multiple droplet actuators) whilst either the light source or detector input is moved. Then, the droplet may be re-stretched to occupy the new path length. This process (e.g., adjusting path length and/or droplet positioning) may also be repeated to obtain multiple measurements for a single droplet.

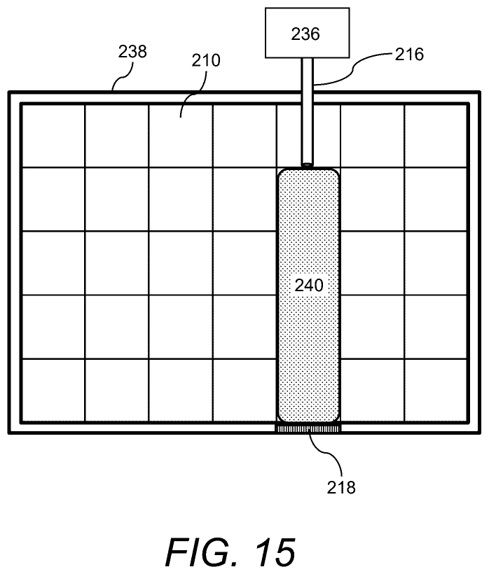

FIG. 15 illustrates an example DMF actuator array 238 with a droplet 240 stretched over several droplet actuators 210 with a single optical fiber 216 capable of transmitting light from a light source (not shown) to droplet 240 and receiving light from droplet 240 to a detector (not shown). More specifically, in this embodiment, single optical fiber 216 serves as both a light input optical fiber as well as a light output optical fiber together with a reflective element 218 (e.g., a mirror) positioned apart and opposite from single optical fiber 216 such that droplet 240 may be disposed therebetween. A combined light source/detector 236 first transmits light through input/output optical fiber 216 where light is received by the droplet 240, is reflected back through the droplet 240, and re-enters input/output optical fiber 216 to be transmitted back to light source/detector 236. The absorbance/transmittance calculation can take into account two passes of the light through the droplet before being received back into the single fiber 216. That is, in a DMF device 200 with a reflector or reflective optical element 218, the optical path length through the droplet 240 would be double the path length of a system without, or a system in which light is only traveling in a single pass from one end of the droplet 240 to the other. Additionally, in some embodiments, in this “parallel” system, as shown, one or more mirrors or reflective optical elements 218 may be used to reflect light back to the detector.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the invention shall also cover any such alternatives, modifications, variations or equivalents. It is intended that the following claims define the scope of the disclosure and that methods and structures within the scope of these claims and their equivalents be covered thereby.

What is claimed is:

1. A digital microfluidic (DMF) device comprising:
an input configured to cause light to be transmitted through a fluid droplet on a surface; and
an output for collecting light transmitted through the fluid droplet on the surface;
wherein the surface is configured to perform one or more droplet operations on the fluid droplet thereby causing a change in a shape of the fluid droplet,
wherein the change in the shape of the fluid droplet alters a path length between the input and the output.

2. The DMF device of claim 1, wherein the DMF device is configured to electronically connect to a DMF system comprising:
a light source electronically connected to the input for providing light to the input;
a detector electronically connected to the output for receiving light from the output; and
a controller electronically connected to the surface, the light source, and the detector, wherein the controller is configured to:
cause the surface to perform the one or more droplet operations on the fluid droplet thereby altering the path length between the input and the output;
cause the light source to transmit light to the input;
cause the detector to receive light from the output;
process a signal generated by the detector in response to receiving the light from the output; and
generate a spectrum based on the signal generated by the detector.

3. The DMF device of claim 2, wherein the spectrum generated by the controller is proportional to the path length.

4. The DMF device of claim 3, wherein either the input, the output, or both the input and the output is an optical guide.

5. The DMF device of claim 4, wherein the optical guide is selected from: a lens, a mirror, an optical fiber, or a fenestration.

6. The DMF device of claim 5, wherein the optical guide is disposed on or adjacent to the surface.

7. The DMF device of claim 6, wherein the optical guide is configured to engagingly contact the fluid droplet.

8. The DMF device of claim 7, wherein the optical guide is moveable thereby enabling the optical guide to engagingly contact the fluid droplet.

9. The DMF device of claim 8, wherein the change in the shape of the fluid droplet caused by the one or more droplet operations causes the fluid droplet to engagingly contact the optical guide.

10. The DMF device of claim 1, wherein the DMF device is configured to electronically connect to a DMF system comprising:
a controller electronically connected to the surface, the input, and the output, wherein the controller is configured to:
cause the surface to perform the one or more droplet operations on the fluid droplet thereby altering the path length between the input and the output;
cause the input to transmit light to through the fluid droplet;
cause the output to receive light transmitted through the fluid droplet;
process a signal generated by the output in response to receiving the light transmitted through the fluid droplet; and
generate a spectrum based on the signal generated by the output.

11. The DMF device of claim 10, wherein the spectrum generated by the controller is proportional to the path length.

12. The DMF device of claim 11, wherein the input is a light source.

13. The DMF device of claim 12, wherein the light source is disposed on or adjacent to the surface.

14. The DMF device of claim 13, wherein the light source is configured to engagingly contact the fluid droplet.

15. The DMF device of claim 14, wherein the light source is moveable thereby enabling the light source to engagingly contact the fluid droplet.

16. The DMF device of claim 15, wherein the change in the shape of the fluid droplet caused by the one or more droplet operations causes the fluid droplet to engagingly contact the light source.

17. The DMF device of claim 16, wherein the output is a sensor.

18. The DMF device of claim 17, wherein the sensor is disposed on or adjacent to the surface.

19. The DMF device of claim 18, wherein the sensor is configured to engagingly contact the fluid droplet.

20. The DMF device of claim 19, wherein the sensor is moveable thereby enabling the sensor to engagingly contact the fluid droplet.

21. The DMF device of claim 20, wherein the change in the shape of the fluid droplet caused by the one or more droplet operations causes the fluid droplet to engagingly contact the sensor.

22. The DMF device of claim 21, further comprising a surface plasmon resonance (SPR) sensor or a localized surface plasmon resonance (LSPR) sensor.

23. A method for spectrochemical analysis, comprising:
providing a fluid droplet to a surface of a digital microfluidic (DMF) device, the DMF device comprising:
an input configured to cause light to be transmitted through the fluid droplet on the surface; and
an output for collecting light transmitted through the fluid droplet on the surface;
positioning the fluid droplet between the input and the output;
changing a shape of the fluid droplet thereby changing a path length between the input and the output;
transmitting light via the input through the fluid droplet;
collecting light transmitted through the fluid droplet via the output; and
generating a spectrum using the light collected by the output, wherein an intensity of the spectrum is proportional to the path length.
